(19) United States
(12) Patent Application Publication
(10) Pub. No.: US 2023/0422359 A1
(43) Pub. Date: Dec. 28, 2023

(54) INDUCTION HEATING-TYPE COOKTOP

(71) Applicant: LG ELECTRONICS INC., Seoul (KR)

(72) Inventors: Euisung KIM, Seoul (KR); Hyunwook MOON, Seoul (KR); Kyungho PARK, Seoul (KR); Yangkyeong KIM, Seoul (KR)

(73) Assignee: LG ELECTRONICS INC., Seoul (KR)

(21) Appl. No.: 18/276,533

(22) PCT Filed: Apr. 9, 2021
(86) PCT No.: PCT/KR2021/004469

§ 371 Date: Aug. 9, 2023

(30) Foreign Application Priority Data
Mar. 5, 2021 (KR) 10-2021-0029224

(51) Int. Cl. H05B 6/12

(52) U.S. Cl. CPC H05B 6/1209

(57) ABSTRACT

An induction heating-type cooktop can include a working coil; an inverter configured to supply current to the working coil, the inverter including a plurality o switching elements; a cooking vessel determination part configured to determine a type of cooking vessel placed on the induction heating-type cooktop; and a controller configured to change a driving method of the inverter based on the type of cooking vessel.

### CROSS-REFERENCE TO RELATED APPLICATIONS

This application is the National Phase of PCT International Application No. PCT/KR2021/004469 filed on Apr. 9, 2021, which claims priority under 35 U.S.C. § 119(a) to Korean Patent Application No. 10-2021-0029224 filed in the Republic of Korea on Mar. 5, 2021, all of which are hereby expressly incorporated by reference into the present application.

### BACKGROUND

### Technical Field

The present disclosure relates to an induction heating-type cooktop, and more particularly, to an induction heating-type cooktop capable of heating both a magnetic substance and a non-magnetic substance.

### Background Art

Various types of cooking appliances are used to heat food at home or in the restaurant. According to the related art, a gas stove using gas as a fuel source has been widely used. However, recently, devices for heating an object to be heated, for example, a cooking vessel such as a pot, have been using electricity instead of the gas.

A method for heating the object to be heated using electricity is largely divided into a resistance heating method and an induction heating method. The electrical resistance method is a method for heating an object by transferring heat generated when electric current flows through a metal resistance wire or a non-metal heating body such as silicon carbide to the object to be heated (e.g., a cooking vessel) through radiation or conduction. In the induction heating method, when high-frequency power having a predetermined intensity is applied to a coil, eddy currents are generated in the object to be heated using magnetic fields generated around the coil so that the object is heated.

In the situation of such an induction heating method, there is a problem in that, even when the same current is applied to a coil, the output power varies depending on what type of material of the cooking vessel is made from. Specifically, a non-magnetic vessel has smaller specific resistance in the same operating frequency band due to lower magnetic permeability than that of a magnetic vessel, and thus an output of the non-magnetic vessel is much less than that of the magnetic vessel.

Thus, a method for improving an output of not only the magnetic vessel but also the non-magnetic vessel is desired. That is, a cooktop capable of heating both the magnetic vessel and the non-magnetic vessel at a high output is desired.

### SUMMARY OF THE DISCLOSURE

An object of the present disclosure is to solve the above problems.

An object of the present disclosure is to provide a cooktop capable of heating both a magnetic vessel and a non-magnetic vessel at a high output.

An object of the present disclosure is to minimize a switching loss in a cooktop including a silicon carbide (SiC) element.

An object of the present disclosure is to minimize a heat generation problem of a switching element in a cooktop including a SiC element.

A cooktop according to an embodiment of the present disclosure uses a SiC element as a switching element.

A cooktop according to an embodiment of the present disclosure uses different power control methods for different types of cooking vessels.

A cooktop according to an embodiment of the present disclosure drives an inverter differently for different types of cooking vessels. Particularly, a cooktop according to an embodiment of the present disclosure changes an operating frequency based on which type of cooking vessel is being used.

One embodiment of the present disclosure provides a cooktop in which a switch having a long duty cycle is disposed close to a heat dissipation fan.

An induction heating-type cooktop according to an embodiment of the present disclosure can include a working coil, an inverter including a plurality of switching elements driven to allow current to flow through the working coil, a cooking vessel determination unit for determining the type of cooking vessel, a controller configured to change a method for driving the inverter according to types of a cooking vessel. Also, the cooking vessel determination unit can be included in the controller (e.g., one or more processors).

The controller can be configured to change the method for driving the inverter so that an operating frequency is adjusted to be greater than or less than a resonant frequency according to which type of cooking vessel is being used.

The controller can be configured to: change the method for driving the inverter to operate in a region equal to or greater than the resonant frequency when the type of the cooking vessel is made from a magnetic substance, and change the method for driving the inverter to operate in a region equal to or less than the resonant frequency when the type of the cooking vessel is made from a non-magnetic substance.

The controller can be configured to adjust a duty cycle of the plurality of switching elements when operating in a region equal to or less than the resonant frequency.

The controller can be configured to adjust a duty cycle of a first switching element of the plurality of switching elements to be less than a duty cycle of a second switching element of the plurality of switching elements.

The duty cycle of the first switching element can be 50% or less.

The second switching element can be disposed closer to a heat dissipation fan than the first switching element.

The controller can be configured to adjust an output by varying in operating frequency when the operating frequency is equal to or greater than the resonant frequency, and the controller can be configured to adjust an output by varying in operating frequency when the operating frequency is equal to or less than the resonant frequency.

When the operating frequency is equal to or less than the resonant frequency, the operating frequency can be set to a fixed frequency.

Each of the plurality of switching elements can include a SiC element.

### ADVANTAGEOUS EFFECTS

According to an embodiment of the present disclosure, since the SiC element is applied to the cooktop, the cooktop can operate in a high frequency band to improve the heating efficiency of the non-magnetic substance.

In addition, according to an embodiment of the present disclosure, since the loss generated in the switching element is minimized as the inverter driving method is changed according to which type of cooking vessel is being used, there can be an advantage in that the heating performance for different vessels made of different materials is secured, and the user convenience is improved since higher outputs can be provided, there is an increase in continuous operation, and the lifespan of the device can be extended.

In addition, since the loss of the switching element is minimized as described above, deterioration of the switching element can be suppressed, and the heat dissipation system such as the heat dissipation fins and the cooling fan can be miniaturized and manufacturing costs can be reduced.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 is a perspective view illustrating a cooktop and a cooking vessel according to an embodiment of the present disclosure.

FIG. 2 is a cross-sectional view illustrating the cooktop and the cooking vessel according to an embodiment of the present disclosure.

FIG. 3 is a circuit diagram of the cooktop according to an embodiment of the present disclosure.

FIG. 4 is a view illustrating output characteristics of the cooktop according to an embodiment of the present disclosure.

FIG. 5 is a view illustrating an operation section of an inverter of the induction heating-type cooktop to which a SiC element is applied according to an embodiment of the present disclosure.

FIG. 6 is a view illustrating electrical operation characteristics of the inverter when different types of cooking vessels are used, according to an embodiment of the present disclosure.

FIG. 7 is a table showing loss according to different types of cooking vessels heated by an induction heating-type cooktop to which a SiC element is applied according to an embodiment of the present disclosure.

FIG. 8 is a block diagram illustrating a control of a cooktop according to an embodiment of the present disclosure.

FIG. 9 is a flowchart illustrating the operating method of the cooktop according to an embodiment of the present disclosure.

FIG. 10 is a view illustrating an operating frequency based on changing or adjusting the driving method of the inverter of the cooktop according to an embodiment of the present disclosure.

FIG. 11 is a view illustrating an example of operating waveforms of the inverter when the cooking vessel of the cooktop is made of a non-magnetic substance according to an embodiment of the present disclosure.

FIG. 12 is a view illustrating an example of a state in which a plurality of switching elements are disposed according to an embodiment of the present disclosure.

FIG. 13 is a graph illustrating the temperature of a plurality of switching elements when a first switching element is disposed closer to a heat dissipation fan than a second switching element in a cooktop according to an embodiment of the present disclosure.

FIG. 14 is a graph illustrating the temperature of a plurality of switching elements when the second switching element is disposed closer to a heat dissipation fan than the first switching element in a cooktop according to an embodiment of the present disclosure.

### DETAILED DESCRIPTION OF THE EMBODIMENTS

Hereinafter, embodiments relating to the present disclosure will be described in detail with reference to the accompanying drawings. Furthermore, terms, such as a “module” ad a “unit,” are used for convenience of description, and they do not have different meanings or functions in themselves.

Hereinafter, an induction heating type cooktop and an operation method thereof according to an embodiment of the present disclosure will be described. For convenience of description, the “induction heating type cooktop” is referred to as a “cooktop.”

The following embodiments can be partially or entirely bonded to or combined with each other and can be linked and operated in technically various ways. The embodiments can be carried out independently of or in association with each other.

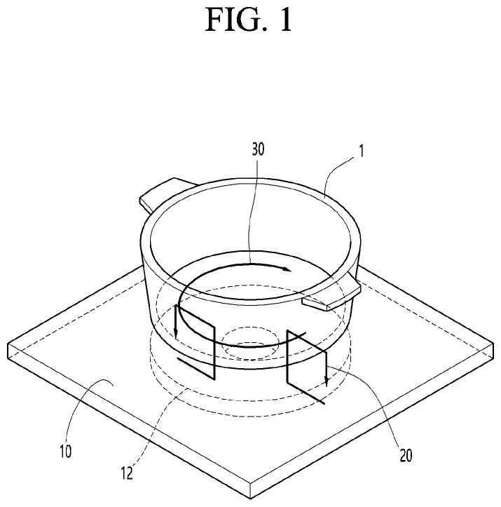

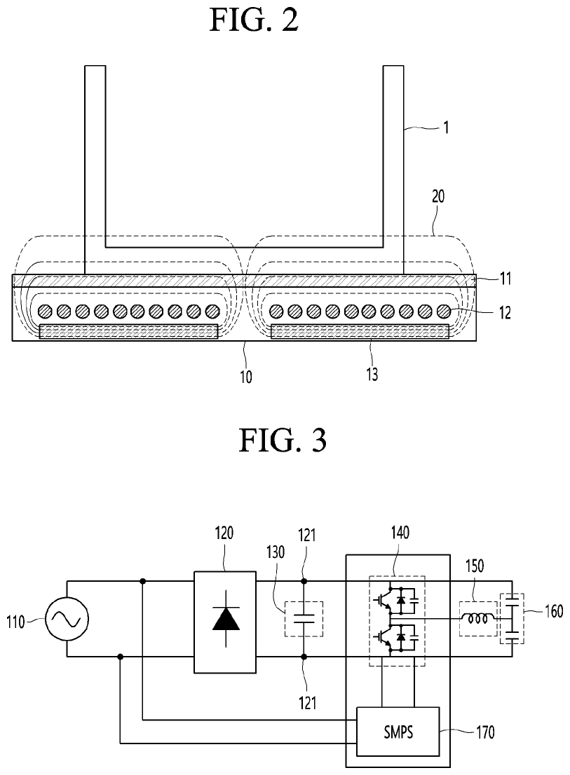

FIG. 1 is a perspective view illustrating a cooktop and a cooking container according to an embodiment of the present disclosure, and FIG. 2 is a cross-sectional view illustrating the cooktop and the cooking container according to an embodiment of the present disclosure.

A cooking vessel 1 can be disposed above or on the cooktop 10, and the cooktop 10 can heat a cooking vessel 1 disposed thereon.

First, a method for heating the cooking vessel 1 using the cooktop 10 will be described.

As illustrated in FIG. 1, the cooktop 10 can generate a magnetic field 20 so that at least a portion of the magnetic field 20 passes through the cooking vessel 1. Here, if an electrical resistance component is contained in a material of the cooking vessel 1, the magnetic field 20 can induce an eddy current 30 in the cooking vessel 1. Since the eddy current 30 generates heat in the cooking vessel 1 itself, and the heat is conducted or radiated up to the inside of the cooking vessel 1, contents of the cooking vessel 1 can be cooked.

When the material of the cooking vessel 1 does not contain the electrical resistance component, the eddy current 30 does not occur. Thus, in this situation, the cooktop 10 may not heat the cooking vessel 1.

As a result, the cooking vessel 1 capable of being heated by the cooktop 10 can be a stainless steel vessel or a metal vessel such as an enamel or cast iron vessel.

Next, a method for generating the magnetic field 20 by the cooktop 10 will be described.

As illustrated in FIG. 2, the cooktop 10 can include at least one of an upper plate glass 11, a working coil 12, or a ferrite 13.

The upper plate glass 11 can support the cooking vessel 1. That is, the cooking vessel 1 can be placed on a top surface of the upper plate glass 11.

In addition, the upper plate glass 11 can be made of ceramic tempered glass obtained by synthesizing various mineral materials. Thus, the upper plate glass 11 can protect the cooktop 10 from an external impact.

In addition, the upper plate glass 11 can prevent foreign substances such as dust, liquids or food from being introduced into the cooktop 10.

The working coil 12 can be disposed below the upper plate glass 11. Current can be supplied to the working coil 12 to generate the magnetic field 20. Specifically, the current can flow through the working coil 12 according to on/off operation of an internal switching element of the cooktop 10.

When the current flows through the working coil 12, the magnetic field 20 can be generated, and the magnetic field 20 can generate the eddy current 30 by meeting the electrical resistance component contained in the cooking vessel 1. The eddy current can heat the cooking vessel 1, and thus, the contents of the cooking vessel 1 can be cooked.

In addition, heating power of the cooktop 10 can be selectively adjusted according to an amount of current flowing through the working coil 12. As a specific example, as the current flowing through the working coil 12 increases, the magnetic field 20 can be become stronger, and thus, since the magnetic field passing through the cooking vessel 1 increases, the heating power of the cooktop 10 can increase.

The ferrite 13 is a component for protecting an internal circuit of the cooktop 10. Specifically, the ferrite 13 serves as a shield to block an influence of the magnetic field 20 generated from the working coil 12 or an electromagnetic field generated from the outside on the internal circuit of the cooktop 10.

For this, the ferrite 13 can be made of a material having very high permeability. The ferrite 13 serves to induce the magnetic field introduced into the cooktop 10 to flow through the ferrite 13 without being radiated through to the other side of the ferrite 13. The movement of the magnetic field 20 generated in the working coil 12 by the ferrite 13 can be as illustrated in FIG. 2.

The cooktop 10 can further include components other than the upper glass 11, the working coil 12, and the ferrite 13 described above. For example, the cooktop 10 can further include an insulator disposed between the upper plate glass 11 and the working coil 12. That is, the cooktop according to the present disclosure is not limited to the cooktop 10 illustrated in FIG. 2.

FIG. 3 is a circuit diagram of the cooktop according to an embodiment of the present disclosure.

Since the circuit diagram of the cooktop 10 illustrated in FIG. 3 is merely illustrative for convenience of description, the embodiment of the present disclosure is not limited thereto.

Referring to FIG. 3, the induction heating type cooktop can include at least some or all of a power supply 110 (e.g., an AC power source), a rectifier 120, a DC link capacitor 130, an inverter 140, a working coil 150, a resonance capacitor 160, and a switching mode power supply (SMPS) 170.

The power supply 110 can receive external power. Power received from the outside to the power supply 110 can be alternating current (AC) power.

The power supply 110 can supply an AC voltage to the rectifier 120.

The rectifier 120 is an electrical device for converting alternating current into direct current. The rectifier 120 converts the AC voltage supplied through the power supply 110 into a DC voltage. The rectifier 120 can supply the converted voltage to both DC ends 121 of the DC link capacitor 130.

An output terminal of the rectifier 120 can be connected to both the DC ends 121 of the DC link capacitor 130. Each of the ends 121 of the DC output through the rectifier 120 can be referred to as a DC link. A voltage measured at each of both the DC ends 121 is referred to as a DC link voltage.

A DC link capacitor 130 serves as a buffer between the power supply 110 and the inverter 140. Specifically, the DC link capacitor 130 is used to maintain the DC link voltage converted through the rectifier 120 to supply the DC link voltage to the inverter 140.

The inverter 140 serves to switch the voltage applied to the working coil 150 so that high-frequency current flows through the working coil 150. The inverter 140 can include a semiconductor switch, and the semiconductor switch can be an insulated gate bipolar transistor (IGBT) or a SiC element. Since this is merely an example, the embodiment is not limited thereto. The inverter 140 drives the semiconductor switch to allow the high-frequency current to flow in the working coil 150, and thus, high-frequency magnetic fields are generated in the working coil 150.

In the working coil 150, current can flow depending on whether the switching element is driven. When current flows through the working coil 150, magnetic fields are generated. The working coil 150 can heat a cooking appliance by generating the magnetic fields as the current flows.

One side of the working coil 150 is connected to a connection point of the switching element of the inverter 140, and the other side of the working coil 150 is connected to the resonance capacitor 160.

The switching element is driven by a driver, and a high-frequency voltage is applied to the working coil 150 while the switching element operates alternately by controlling a switching time output from the driver. In addition, since a turn on/off time of the switching element applied from the driver is controlled in a manner that is gradually compensated, the voltage supplied to the working coil 150 is converted from a low voltage into a high voltage.

The resonance capacitor 160 can be a component to serve as a buffer. The resonance capacitor 160 controls a saturation voltage increasing rate during the turn-off of the switching element to affect an energy loss during the turn-off time.

The SMPS 170 (switching mode power supply) refers to a power supply that efficiently converts power according to a switching operation. The SMPS 170 converts a DC input voltage into a voltage that is in the form of a square wave and then obtains a controlled DC output voltage through a filter. The SMPS 170 can minimize unnecessary loss by controlling a flow of the power using a switching processor.

In the cooktop 10 expressed by the circuit diagram illustrated in FIG. 3, a resonance frequency is determined by an inductance value of the working coil 150 and a capacitance value of the resonance capacitor 160. Then, a resonance curve can be formed around the determined resonance frequency, and the resonance curve can represent output power of the cooktop 10 according to a frequency band.

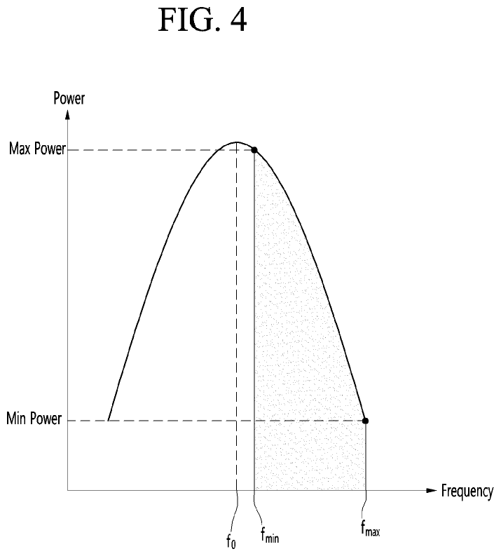

Next, FIG. 4 is a view illustrating output characteristics of the cooktop according to an embodiment of the present disclosure.

First, a Q factor (quality factor) can be a value representing sharpness of resonance in the resonance circuit. Therefore, in the situation of the cooktop 10, the Q factor is determined by the inductance value of the working coil 150 included in the cooktop 10 and the capacitance value of the resonant capacitor 160. The resonance curve can be different depending on the Q factor. Thus, the cooktop 10 has different output characteristics according to the inductance value of the working coil 150 and the capacitance value of the resonant capacitor 160.

FIG. 4 illustrates an example of the resonance curve according to the Q factor. In general, the larger the Q factor, the sharper the shape of the curve, and the smaller the Q factor, the broader the shape of the curve.

A horizontal axis of the resonance curve can represent a frequency, and a vertical axis can represent output power. A frequency at which maximum power is output in the resonance curve is referred to as a resonance frequency f₀.

In general, the cooktop 10 uses a frequency in a right region based on the resonance frequency f₀ of the resonance curve (e.g., a point to the right of f₀). In addition, the cooktop 1 can have a minimum operating frequency and a maximum operating frequency, which are set in advance.

For example, the cooktop 10 can operate at a frequency corresponding to a range from the minimum operating frequency fₘᵢₙ to the maximum operating frequency fₘₐₓ. That is, the operating frequency range of the cooktop 10 can be from the minimum operating frequency fₘᵢₙ to the maximum operating frequency fₘₐₓ.

For example, the maximum operating frequency fₘₐₓ can be an IGBT maximum switching frequency. The IGBT maximum switching frequency can mean a maximum driving frequency determined in consideration of a resistance voltage and capacity of the IGBT switching element. For example, the maximum operating frequency fₘₐₓ can be 75 kHz.

The minimum operating frequency fₘᵢₙ can be about 20 kHz. In this situation, since the cooktop 10 does not operate at an audible frequency (about 16 Hz to 20 kHz), noise of the cooktop 10 can be reduced.

Since setting values of the above-described minimum operating frequency fₘᵢₙ, and maximum operating frequency fₘₐₓ are only examples, the embodiment of the present disclosure is not limited thereto.

When receiving a heating command, the cooktop 10 can determine an operating frequency according to a heating power level set by the heating command. Specifically, the cooktop 10 can dynamically adjust the output power by decreasing in operating frequency as the set heating power level is higher and increasing in operating frequency as the set heating power level is set lower. That is, when receiving the heating command, the cooktop 10 can perform a heating mode in which the cooktop operates in one of the operating frequency ranges according to the set heating power.

The cooktop 10 requires a large amount current to improve heating efficiency of not only for the magnetic substance but also for the non-magnetic cooking vessel 1.

Since the allowable current of the insulated-gate bipolar transistor (IGBT) element is low as the frequency increases, the heating efficiency of the non-magnetic cooking vessel 1 can be limited.

The SiC element can tolerate high current, but due to element characteristics, the higher the current, the greater a power loss. Therefore, a cooktop capable of minimizing power loss is desired.

Thus, an object of the present disclosure is to provide a cooktop 10 that minimizes power loss while using the inverter 140 that includes the SiC element to heat different types of cooking vessels 1.

In the present specification, the magnetic substance can mean a material having ferromagnetism (ferromagnetic substance), and the non-magnetic substance can include a material having weak magnetism other than the ferromagnetic substance (weak magnetic substance) or a material having no magnetism at all.

In addition, in the present specification, when the cooking vessel 1 is made of the magnetic substance, the expression of voltage/current/resistance/power, etc. is large (high)/small (low) means that the voltage/current/resistance/power, etc. is relatively large (high) or small (low) compared to the situation in which the cooking vessel 1 is made of the non-magnetic substance, conversely, when the cooking vessel 1 is made of the non-magnetic substance, the expression of voltage/current/resistance/power, etc. is large (high)/small (low) means that the voltage/current/resistance/power, etc. is relatively large (high) or small (low) compared to the situation in which the cooking vessel 1 is made of the magnetic substance.

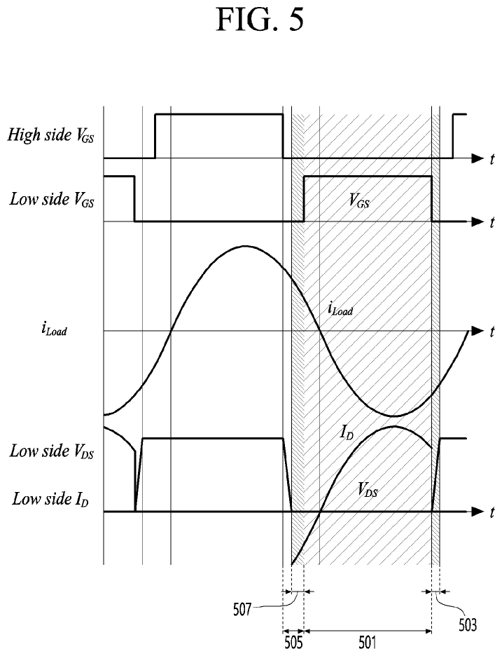

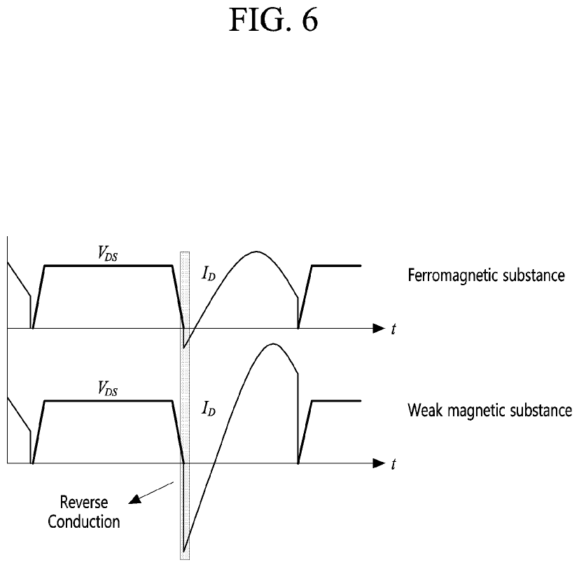

FIG. 5 is a view illustrating an operation section of the inverter of the induction heating-type cooktop to which the SiC element is applied, and FIG. 6 is a view illustrating electrical operation characteristics of the inverter according to different types of cooking vessels.

Referring to the example of FIG. 5, the operation section of the inverter 140 can be divided into a channel conduction section 501, a switch turn-off section 503, and a dead time section 505.

The channel conduction section 501 can be a section in which current flows through a channel inside the SiC element.

The switch turn-off section 503 can be a section in which a switch turn-off loss occurs during the turn-off section of the SiC element.

The dead time section 505 can be a section for safe operation when the SiC element is turned on. The dead time section can include a reverse conduction section 507 in which the current flows through an internal diode.

Since the current flows through the internal diode in the reverse conduction section, especially when the cooking vessel 1 is made of the non-magnetic substance, high current can flow through the SiC element, and thus, a large power loss can occur in the reverse conduction section.

In detail, when the cooking vessel 1 is made of the magnetic substance, it has large equivalent resistance (e.g., about 2 to 3Ω) when magnetically coupled to the working coil 150, and as illustrated in FIG. 6, since a phase difference between the resonance voltage and current is small, rated power can be secured even at low current.

When the cooking vessel 1 is made of the non-magnetic substance, it has low equivalent resistance (e.g., about 1Ω or less) when magnetically coupled to the working coil 150, and as illustrated in FIG. 6, since a phase difference between the resonance voltage and current is large, high current may be required to secure the rated power.

Therefore, since higher current flows when heating the non-magnetic cooking vessel 1, the power loss also increases in the reverse conduction section. This is done for a reason, in which the SiC element has a low loss characteristic because the on-resistance (Rds(on)) of the channel is very small in terms of structure, but the internal diode (body diode) of the SiC element does not have a low loss characteristic, and thus, although the reverse conduction section in which the current flows through the internal diode is relatively short, a large power loss occurs.

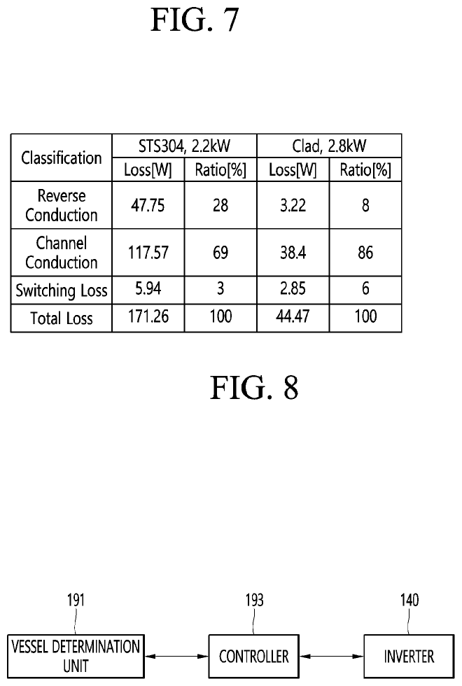

The increase in power loss according to the type of the cooking vessel 1 can be confirmed through the table shown in FIG. 7.

FIG. 7 is a table showing a loss according to types of cooking vessels heated by the induction heating-type cooktop to which the SiC element is applied.

In the table illustrated in FIG. 7, STS 304 is an example of the non-magnetic cooking vessel 1, and clad is an example of the magnetic cooking vessel 1.

Referring to FIG. 7, it is seen that a loss ratio in the reverse conduction section is 8% when the cooking vessel 1 is made of the magnetic substance, but increases very significantly to 28% when the cooking vessel 1 is made of the non-magnetic substance.

Thus, the present disclosure intends to minimize the loss even when the cooking vessel 1 is made of the non-magnetic substance. For this, in the cooktop 10 according to an embodiment of the present disclosure, the switching element can be designed in a bridge shape or a bridge configuration, the resonance capacitor 160 can be designed in a bridge shape or a bridge configuration to be able to respond to large resonance current, and the working coil 150 can be connected between the inverter 140 and the resonant capacitor 160.

In addition, the cooktop 10 can change the driving method of the inverter 140 according to which type of the cooking vessel 1 is being used. For this, the cooktop 10 can automatically determine which type of cooking vessel 1 is being used.

FIG. 8 is a block diagram illustrating a control of the cooktop according to an embodiment of the present disclosure.

In FIG. 8, only one example of components that are necessary to explain the control method of the cooktop 10 according to the present disclosure is illustrated, and some of the components illustrated in FIG. 8 can be omitted, or other components that are not illustrated in FIG. 8 can be added.

The cooktop 10 can include a vessel determination unit 191, a controller 193 (e.g., one or more processors), and an inverter 140. Also, the vessel determination unit 191 can include one or more sensors or can be included within the controller (e.g., one or more processors), but embodiments are not limited thereto.

The inverter 140 can include a plurality of switching elements driven to allow current to flow through the working coil 150. For example, the plurality of switching elements can be SiC (silicon carbide) elements, but embodiments of the present disclosure are not limited thereto. For example, the plurality of switching elements can be gallium nitride (GaN) elements. That is, the plurality of switching elements can be wide band-gap (WBG) elements.

The vessel determination unit 191 can determine the type of cooking vessel 1. In more detail, the vessel determination unit 191 can determine a material of the cooking vessel 1. In summary, the vessel determination unit 191 can acquire the type of cooking vessel 1 or the material of the cooking vessel 1. The type of cooking vessel 1 can be a concept including the material of the cooking vessel 1.

The vessel determination unit 191 can determine the type of cooking vessel 1 in various manners. For example, the vessel determination unit 191 can include one or more sensors. Also, according to an embodiment, the controller 193 can be configured to determine the type of cooking vessel 1.

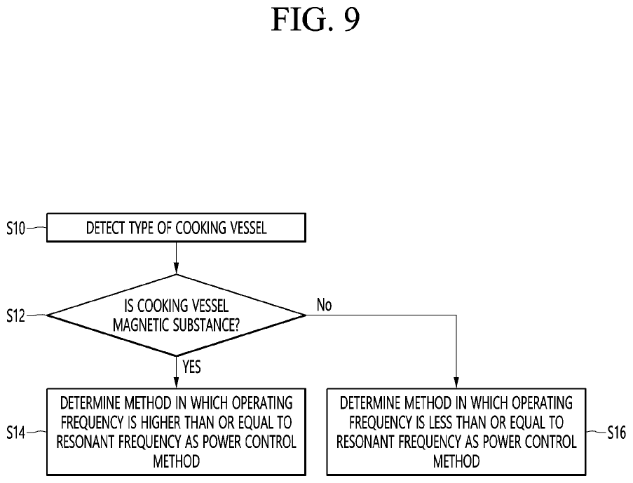

The controller 193 can change the driving method of the inverter 140 according to the type of cooking vessel 1. For example, the controller 193 can use different driving methods for controlling the inverter 140 for different types of cooking vessels. Referring to FIG. 9, a method of changing the driving method of the inverter 140 according to the type of cooking vessel 1 will be described in more detail.

FIG. 9 is a flowchart illustrating an operating method of the cooktop according to an embodiment of the present disclosure.

The controller 193 can control the vessel determination unit 191 to detect which type of cooking vessel 1 is place on the cooktop (S10).

The controller 193 can acquire or determine whether the cooking vessel 1 is made of the magnetic substance (S12).

On the other hand, the controller 193 can acquire or determine whether the cooking vessel 1 is made of the non-magnetic substance.

If the cooking vessel 1 is made of the magnetic substance, the controller 193 can determine a method in which an operating frequency is higher than or equal to a resonant frequency as the power control method (S14).

That is, if the type of cooking vessel 1 is made of the magnetic substance, the controller 193 can change the driving method of the inverter 140 to operate in a region that is equal to or higher than the resonant frequency.

If the cooking vessel 1 is made of the non-magnetic substance, the controller 193 can determine a method in which an operating frequency is less than or equal to the resonant frequency as the power control method (S16).

That is, if the type of cooking vessel 1 is made of the non-magnetic substance, the controller 193 can change the driving method of the inverter 140 to operate in a region that is lower than the resonant frequency.

In summary, the controller 193 can change the driving method of the inverter 140 so that the operating frequency is adjusted to be higher or lower than the resonant frequency according to which type of cooking vessel 1 is place on the cooktop.

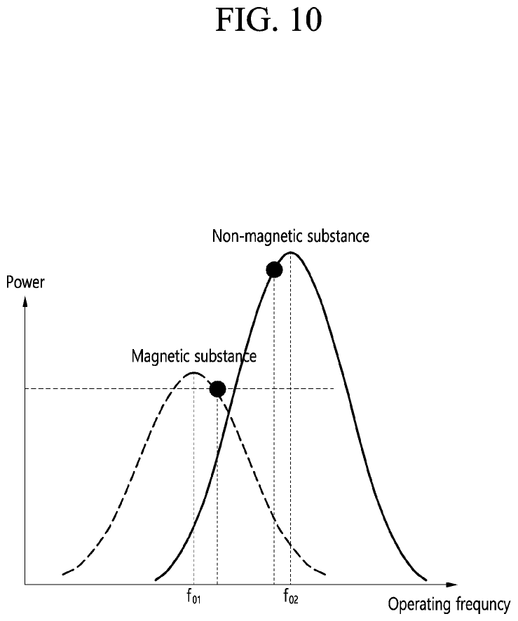

FIG. 10 is a view illustrating the operating frequency according to a change in inverter driving method of the cooktop according to an embodiment of the present disclosure.

In the example of FIG. 10, the first resonance frequency f₀₁ can be a resonance frequency when the cooking vessel 1 is made of the magnetic substance, and the second resonance frequency f₀₂ can be a resonance frequency when the cooking vessel 1 is made of the non-magnetic substance.

The cooktop 10 can control the inverter 140 so that the operating frequency is set higher than the first resonant frequency f₀₁ when the cooking vessel 1 is made of the magnetic substance, and the cooktop 10 can control the inverter 140 so that the operating frequency is equal to or less than the second resonant frequency f₀₂ when the cooking container 1 is made of the non-magnetic substance.

When the controller 193 controls the operating frequency to be equal to or higher than the first resonant frequency f₀₁, the controller 193 can change an output by varying the operating frequency according to a heating power level. That is, the controller 193 can adjust the output by varying the operating frequency when the operating frequency is equal to or higher than the resonant frequency. When the cooking vessel 1 is made of the magnetic substance, the controller 193 can adjust the output to be in a region that is above a resonance point by a pulse frequency modulation (PFM) control method.

In addition, when the controller 193 controls the operating frequency to be equal to or less than the second resonant frequency f₀₂, the controller 193 can change the output by varying the duty cycle according to the heating power level. That is, the controller 193 can adjust the output by adjusting the duty cycle of the plurality of switching elements when the operating frequency is less than or equal to the resonant frequency. When the operating frequency is equal to or less than the resonant frequency, the operating frequency can be a fixed frequency. When the cooking vessel 1 is made of the non-magnetic substance, the controller 193 can adjust the output to be in a region that is below the resonance point using the pulse width modulation (PWM) control method.

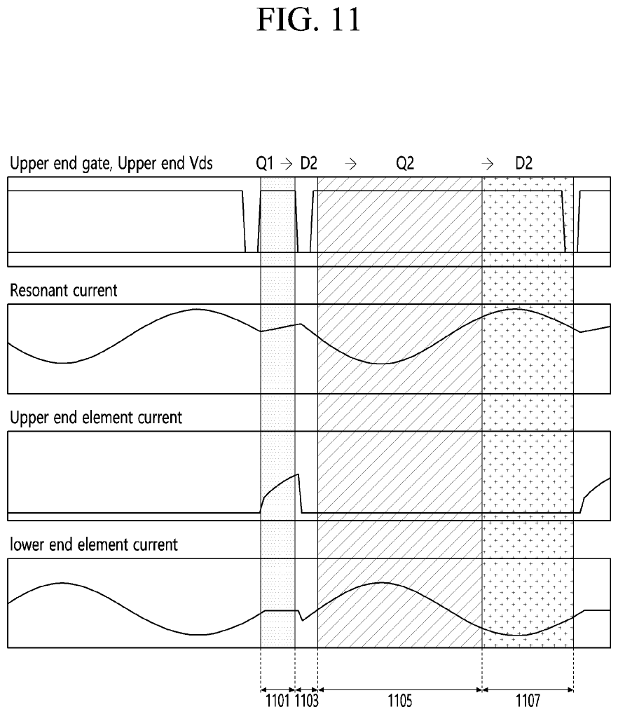

FIG. 11 is a view illustrating an example of operating waveforms of the inverter 140 when the cooking vessel of the cooktop is made of the non-magnetic substance according to an embodiment of the present disclosure.

The controller 193 can control the inverter 140 to operate in a region below the resonant frequency when the cooking vessel 1 is made of the non-magnetic substance and can adjust the duty cycle of the plurality of switching elements when operating in the region below the resonance frequency.

The controller 193 can adjust the duty cycle of the first switching element among the plurality of switching elements to be smaller than the duty cycle of the second switching element. The controller 193 can adjust the duty cycle of the first switching element to set to the first duty cycle and can adjust the duty cycle of the second switching element to a section remaining after subtracting the first duty cycle from the entire cycle (100%). The first duty cycle can be set to 50% or less, and the second duty cycle can be carried out during the remaining portion of the entire cycle. Also, the second duty cycle can be set to 50% or more. For example, the first duty can be set to 30%, and the second duty can be set to 70%.

In FIG. 11, the first section 1101 can be a section in which the first switching element is turned on, and the third section 1105 can be a section in which the second switching element is turned on. The second section 1103 can be a section between the first section 1101 and the third section 1105, and the fourth section 1107 can be a section between the second section 1105 and the first section 1101.

When the second section 1103 is changed to the third section 1105, the current flows through the internal diode of the second switching element and then flows into the second switching element, and thus, there can be an advantage that no switching loss occurs because a zero-voltage switch (ZVS) is turned on. In addition, when changing from the fourth section 1107 to the first section 1101, the current flows through the internal diode of the second switching element and then flows into the first switching element, and thus, a slight loss due to reverse current occurs.

That is, referring to FIG. 11, in the first switching element, although the loss occurs once due to hard switching, since the current is low in the reverse conduction section, the amount of the loss is small. In addition, since no loss occurs due to soft switching in the second switching element, and only a slight loss occurs in the channel conduction section, there can be advantage in that an increase in the amount of loss is suppressed.

In this situation, since the second switching element has a duty cycle that is longer than the duty cycle of the first switching element, the amount of heat that is generated can slightly increase. That is, as described above, when the cooking vessel 1 of the cooktop 10 is made of the non-magnetic substance, and the operating frequency is controlled below the resonant frequency, the amount of generated heat in the second switching element can be greater than the amount of heat generated in the first switching element. Thus, in the cooktop 10 according to an embodiment of the present disclosure, the second switching element can be disposed closer to the heat dissipation fan than the first switching element.

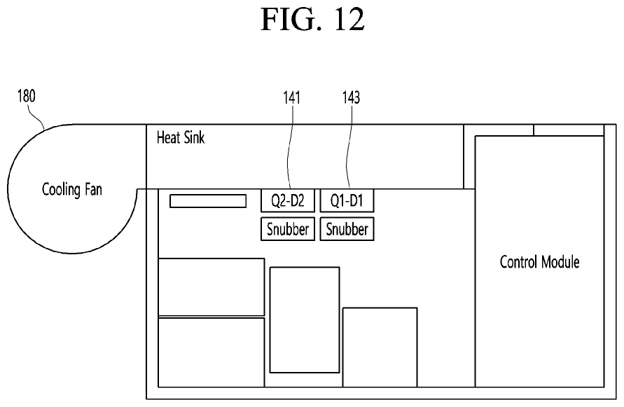

FIG. 12 is a view illustrating an example of a state in which the plurality of switching elements are disposed according to an embodiment of the present disclosure.

As illustrated in FIG. 12, the cooktop 10 can further include a heat dissipation fan 180 for cooling the internal components. The second switching element 141 can be disposed closer to the heat dissipation fan 180 than the first switching element 143. That is, the switching element that has the longest duty cycle among the plurality of switching elements can be disposed closest to the heat dissipation fan 180.

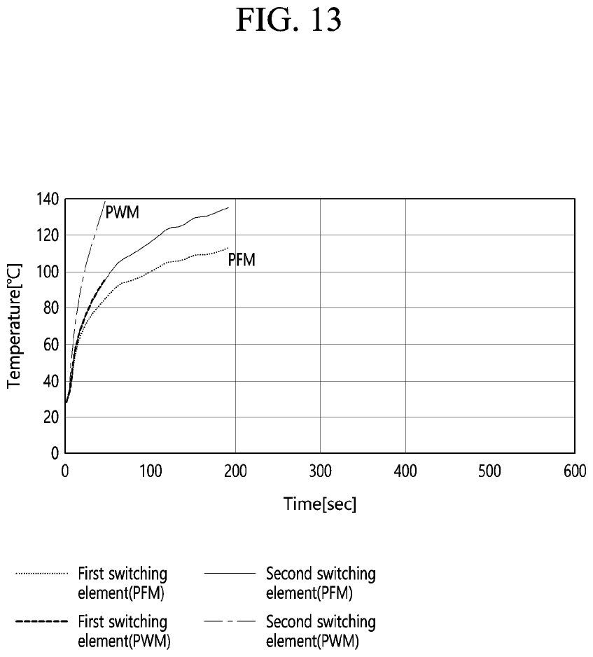

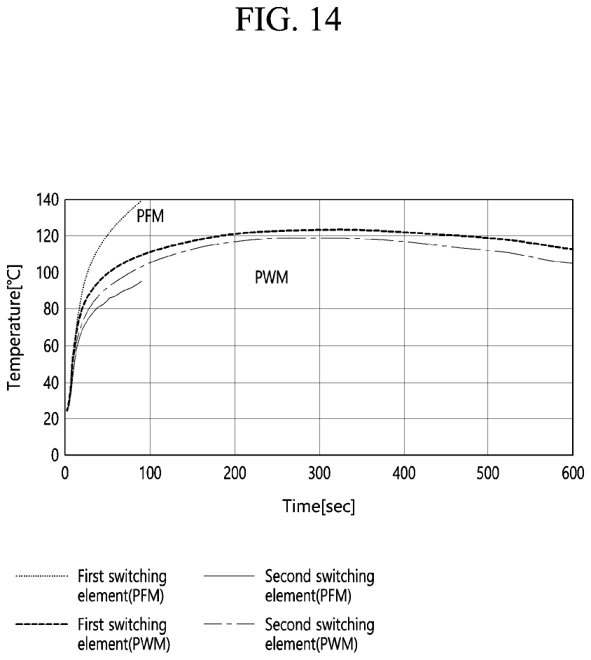

FIG. 13 is a graph illustrating the temperatures of the plurality of switching elements when the first switching element is disposed closer to the heat dissipation fan than the second switching element in the cooktop according to an embodiment of the present disclosure, and FIG. 14 is a graph illustrating the temperatures of the plurality of switching elements when the second switching element is disposed closer to the heat dissipation fan than the first switching element in the cooktop according to an embodiment of the present disclosure.

Here, the first switching element can be a switching element controlled to have a shorter duty cycle than the second switching element, and conversely, the second switching element can be a switching element controlled to have a longer duty cycle than the first switching element. Therefore, it is assumed that the amount of heat generated in the second switching element is greater than the amount of heat generated in the first switching element.

Referring to FIG. 13, since the second switching element having a relatively large amount of heat is disposed farther away from the heat dissipation fan than the first switching element, it can be seen that the temperature of the second switching element rises rapidly.

Referring to FIG. 14, since the second switching element having a relatively large amount of heat is disposed closer to the heat dissipation fan than the first switching element, a temperature of the second switching element rises much more slowly than compared to the situation shown in FIG. 13. For example, it can be confirmed that the temperature rise curves of the device and the second switching element are similar to each other.

In summary, in the cooktop 10 according to an embodiment of the present disclosure, if the cooking vessel 1 is made of the magnetic substance, the power control can be performed by the frequency control method in the frequency domain above the resonance point, and if the cooking vessel 1 is made of the non-magnetic substance, the power control can be performed by a duty cycle control method in a region below the resonance point. Thus, there can be an advantage in that the heating performance for cooking vessels made of various materials can be secured by minimizing the amount of loss occurring in the switching element, thereby providing improved convenience to the user and advantages such as high power, an increase in continuous operation time, and improved lifespan of the cooktop.

In addition, since the plurality of switching elements of the cooktop 10 having a longer duty cycle are disposed closer to the heat dissipation fan than the switching elements having a shorter duty cycle, there can be advantage in that a deterioration rate of the switching elements can be minimized, and the heat dissipation fins and the heat dissipation fan are miniaturized and costs are reduced.

The above-disclosed subject matter is to be considered illustrative, and not restrictive, and the appended claims are intended to cover all such modifications, enhancements, and other embodiments, which fall within the true spirit and scope of the present disclosure.

Thus, the embodiment of the present disclosure is to be considered illustrative, and not restrictive, and the technical spirit of the present disclosure is not limited to the foregoing embodiment.

Therefore, the scope of the present disclosure is defined not by the detailed description of the invention but by the appended claims, and all differences within the scope will be construed as being included in the present disclosure.

1-10. (canceled)

11. An induction heating-type cooktop comprising:
a working coil;
an inverter configured to supply current to the working coil, the inverter including a plurality of switching elements;
a cooking vessel determination part configured to determine a type of cooking vessel placed on the induction heating-type cooktop; and
a controller configured to change a driving method of the inverter based on the type of cooking vessel.

12. The induction heating-type cooktop according to claim 11, wherein the controller is further configured to change the driving method of the inverter to an operating frequency that is greater than or less than a resonant frequency based on the type of cooking vessel.

13. The induction heating-type cooktop according to claim 12, wherein the controller is further configured to, in response to the operating frequency being set to a value that is less than or equal to the resonant frequency, adjust a duty cycle of the plurality of switching elements.

14. The induction heating-type cooktop according to claim 13, wherein the controller is further configured to adjust a first duty cycle of a first switching element among the plurality of switching elements to be less than a second duty cycle of a second switching element among the plurality of switching elements.

15. The induction heating-type cooktop according to claim 14, wherein the first duty cycle of the first switching element is set to 50% or less.

16. The induction heating-type cooktop according to claim 15, wherein the second duty cycle of the second switching element is set to 50% or more.

17. The induction heating-type cooktop according to claim 14, further comprising a heat dissipation fan configured to cool the plurality of switching elements,
wherein the second switching element is disposed closer to the heat dissipation fan than the first switching element.

18. The induction heating-type cooktop according to claim 12, wherein the controller is further configured to:
when the operating frequency is set equal to or greater than the resonant frequency, adjust a heating output of the induction heating-type cooktop by varying the operating frequency; and
when the operating frequency is set equal to or less than the resonant frequency, adjust the heating output of the induction heating-type cooktop by changing a duty cycle of one or more switching elements among the plurality of switching elements.

19. The induction heating-type cooktop according to claim 18, wherein the controller is further configured to, when the operating frequency is set equal to or less than the resonant frequency, set the operating frequency to a fixed frequency.

20. The induction heating-type cooktop according to claim 11, wherein the controller is further configured to:
when the type of the cooking vessel includes a magnetic substance, change the driving method of the inverter to operate at an operating frequency that is equal to or greater than a resonant frequency; and
when the type of the cooking vessel includes a non-magnetic substance, change the driving method of the inverter to operate at an operating frequency that is equal to or less than the resonant frequency.

21. The induction heating-type cooktop according to claim 11, wherein one or more of the plurality of switching elements includes a silicon carbide (SiC) element.

22. An induction heating-type cooktop comprising:
a working coil configured to heat a cooking vessel;
an inverter configured to supply current to the working coil, the inverter including a plurality of switching elements; and
a controller configured to:
in response to the cooking vessel being a magnetic type of cooking vessel, set an operating frequency of the inverter to a value that is greater than a first resonate frequency; and
in response to the cooking vessel being a non-magnetic type of cooking vessel, set the operating frequency of the inverter to a value that is less than a second resonate frequency.

23. The induction heating-type cooktop according to claim 22, wherein the second resonate frequency based on the non-magnetic type of cooking vessel is greater than the first resonate frequency based on the magnetic type of cooking vessel.

24. The induction heating-type cooktop according to claim 22, wherein the controller is further configured to:
in response to the cooking vessel being the magnetic type of cooking vessel, adjust a heating output of the induction heating-type cooktop by varying the operating frequency; and
in response to the cooking vessel being the non-magnetic type of cooking vessel, adjust the heating output of the induction heating-type cooktop by changing a duty cycle of one or more switching elements among the plurality of switching elements.

25. The induction heating-type cooktop according to claim 24, wherein the controller is further configured to adjust a first duty cycle of a first switching element among the plurality of switching elements to be less than a second duty cycle of a second switching element among the plurality of switching elements.

26. The induction heating-type cooktop according to claim 25, further comprising a heat dissipation fan configured to cool the plurality of switching elements,
wherein the second switching element is disposed closer o the heat dissipation fan than the first switching element.

27. The induction heating-type cooktop according to claim 22, wherein one or more of the plurality of switching elements includes a silicon carbide (SiC) element or a gallium nitride (GaN) element.

28. The induction heating-type cooktop according to claim 22, wherein the controller is further configured to adjust the operating frequency based on a pulse width modulation (PWM) control method.

29. An induction heating-type cooktop comprising:
a working coil configured to heat a cooking vessel;
an inverter configured to supply current to the working coil, the inverter including a plurality of switching elements; and
a controller configured to:
in response to the cooking vessel being a magnetic type of cooking vessel, adjust a heating output of the induction heating-type cooktop by varying an operating frequency of the inverter; and
in response to the cooking vessel being a non-magnetic type of cooking vessel, adjust the heating output of the induction heating-type cooktop by changing a duty cycle of one or more switching elements among the plurality of switching elements.

30. The induction heating-type cooktop according to claim 29, wherein one or more of the plurality of switching elements includes a silicon carbide (SiC) element or a gallium nitride (GaN) element.
